(19) United States
(12) Patent Application Publication
(10) Pub. No.: US 2005/0051503 A1
(43) Pub. Date: Mar. 10, 2005

(54) Coalescer media flexible container and method of use

(76) Inventors: Robert W. Holland, Newark, OH (US); Jerry L. Waller, Newark, OH (US); Daniel J. Martin, Newark, OH (US); Steven M. Abrams, New Albany, OH (US); Stephen L. Fort, Owensboro, KY (US); Charles W. Travelstead, Albuquerque, NM (US); Jeffery W. Jones, Owensboro, KY (US)

Correspondence Address: Patrick P. Phillips;Kremblas, Foster, Phillips & Pollick, 7632 Slate Ridge Boulevard, Reynoldsburg, OH, 43068, US

(21) Appl. No.: 10/655,715

(22) Filed: Sep. 6, 2003

(51) Int. Cl. B01D 17/00

(52) U.S. Cl. 210/791; 210/538; 210/DIG. 5

(57) ABSTRACT

A coalescer media flexible container for retaining coalescer media in the coalescer chamber of an oil-water separator is provided having a flexible enclosure and a randomly arranged, loosely packed coalescing medium. The flexible container has a top surface connected to a bottom surface. The flexible enclosure conforms to the shape of the coalescer chamber in which the flexible enclosure is placed. The flexible enclosure has an interior, with the flexible enclosure fabricated so as to permit liquids to easily pass into the interior of the flexible enclosure where the randomly arranged, loosely packed coalescing medium is retained. The flexible enclosure is preferably fabricated from a group of materials including plastic mesh, reinforced aerated plastic bags, wire mesh, fabric mesh, and netting. Furthermore, in at least one embodiment of the invention, a planar sheetform member is located in the interior of the flexible enclosure directly adjacent the bottom surface. Preferably each flexible enclosure includes a pair of retrieval means. A method of use is also disclosed.

### BACKGROUND OF THE INVENTION

1. Field of the Invention

This invention relates generally to an oil water separator system, and more particularly to a coalescer media container utilized in such systems, and even more particularly to a coalescer media flexible container utilized in such systems and its method of use.

2. Description of the Related Art

The use of gravity type liquid separators to separate a mixture of liquids of different densities is longstanding. An important use of these liquid separators is in treatment of storm water and waste water discharge. Other uses include removal of animal fat from water in food processing applications and removal of free-floating hydrocarbons and certain other chemicals from water in industrial applications.

For example, an industrial user who controls or collects storm water and discharges it through a pipe, drain or other outlet, into a sewer system or navigable waterway must comply with the National Pollutant Discharge Elimination System (NPDES). Mandated by Congress under Section 402 of the Clean Water Act, the NPDES storm water program is a two-phased approach to eliminating or reducing accidental and chronic low-level releases of oil-polluted water. A working oil water separator is an important part of a storm water drainage system designed for facility compliance with the NPDES storm water program.

Governmental regulations specify the maximum amount of hydrocarbons that may be present in waste water discharge. Currently, the acceptable amount might typically be 10-15 parts per million (ppm).

In the simplest separators, an open tank or holding area is utilized. The lighter than water oil globules rise through the liquid mixture. The free oil is then skimmed off. ⅛⅛Other separator designs include plates which are incorporated within the container or tank to speed up the process of coalescing oil droplets. It is known that separation of liquids is enhanced by using a coalescing process.

One example is seen in Schmit et al, U.S. Pat. No. 4,802,978, which provides a forced flow type oil/water separator utilizing arranged parallel plates with corrugated surfaces. Castelli, U.S. Pat. No. 4,897,206, discloses corrugated separator plates having corrugations running in orthogonal directions. Bleed holes are provided in both the crests and the valleys of the plates.

A further separator design incorporates two stages. As an example, Aymong, U.S. Pat. No. 4,722,800, discloses a separator having two chambers, a small inlet chamber having a baffle to reduce and deflect inlet turbulence, and a relatively large separator chamber.

All of the aforementioned prior art separators which include a coalescing medium include structured plates or other medium which have a fixed structure and form. A disadvantage associated with rigid frame containers is that they typically have a slight gap, about ⅛″ between adjacent containers, otherwise they are too difficult to remove for required cleaning, maintenance, and replacement. However, these gaps permit contaminated water to easily flow through the unit.

Keep, U.S. Pat. No. 5,229,015 discloses the use of a liquid separator having a random packed coalescing medium without the use of a framed unit to contain them. One Underwriters Laboratories (UL) listing of a container with random packed coalescing medium requires 2300 coalescing media per cubic foot.

Cleaning the random packed media as used in Keep is difficult and time consuming. Use of a medium similar to what is shown in Keep has also been used in containers having structured plates with a fixed, rigid structure and form. Although the random packed coalescing medium is effective in removing oil from contaminated water, they are difficult to clean in the prepackaged form in part because it is hard to remove the structured containers with their rigid frame from the frame designed to accommodate the individual prepackaged containers. Furthermore, once removed for cleaning, the prepackaged units are equally hard to get back in place within the frame designed to accommodate the prepackaged containers.

Given the problems associated with current prepackaged coalescer media units, it is apparent that the need exists for a prepackaged coalescer media unit which can relatively easily be removed from the coalescer chamber and also relatively easily be placed and replaced into the coalescer chamber.

### SUMMARY OF THE INVENTION

In accordance with the present invention, there is disclosed a coalescer media flexible container for retaining coalescer media in the coalescer chamber of an oil-water separator, with the coalescer media flexible container having a flexible enclosure and a randomly arranged, loosely packed coalescing medium. The flexible container has a top surface and a bottom surface, with the top surface and the bottom surface being connected to each other. The flexible enclosure conforms to the shape of the coalescer chamber in which the flexible enclosure is placed. The flexible enclosure has an interior, with the flexible enclosure fabricated so as to permit liquids, and particularly oil, to easily pass into the interior of the flexible enclosure. The randomly arranged, loosely packed coalescing medium is retained in the interior of the flexible enclosure.

The flexible enclosure is preferably fabricated from a group of materials including plastic mesh, reinforced aerated plastic bags, wire mesh, fabric mesh, and netting. More specifically, the flexible enclosure can be fabricated from polypropylene. Furthermore, in at least one embodiment of the invention, a planar sheetform member is located in the interior of the flexible enclosure directly adjacent the bottom surface. In such embodiments, the sheetform member can be secured to the bottom surface.

Preferably the flexible enclosure has secured thereto retrieval means. More preferably, the retrieval means are secured to the top surface of the flexible enclosure. Preferably each flexible enclosure includes a pair of retrieval means, one retrieval means being located near each of the opposite ends of the flexible enclosure.

There is also disclosed in combination a coalescer chamber of an oil-water separator and at least one coalescer media flexible container for retaining coalescer media in the coalescer chamber. The coalescer chamber includes a frame and a lid, with the frame also having a base. The frame has secured thereto first and second sidewalls as front and back walls, with the first and second sidewalls fabricated so as to permit liquids, and particularly oil, to easily pass therethrough.

The coalescer media flexible container includes a flexible enclosure containing randomly arranged, loosely packed coalescing media, with the flexible enclosure having a top surface and a bottom surface, with the top surface and the bottom surface being connected to each other. The flexible enclosure conforms to the shape of the coalescer chamber in which the flexible enclosure is placed. The flexible enclosure has an interior, with the flexible enclosure fabricated so as to permit liquids, and particularly oil, to easily pass into the interior of the flexible enclosure.

In the combination, the coalescer chamber sidewalls are preferably fabricated from a metallic or non-metallic mesh screening or expanded metal. The frame has attached thereto a pair of anchoring rods, with the anchoring rods extending substantially parallel to the coalescer chamber sidewalls which preferably are the front and back walls of the coalescer chamber.

In at least one embodiment of the combination, the coalescer media flexible container includes a planar sheetform member which is placed in the interior of the flexible enclosure directly adjacent the bottom surface. The bottom surface of the flexible container is also directly adjacent the coalescer chamber frame base.

In the combination, the coalescer media flexible container has retrieval means secured to the top surface of the flexible enclosure. In the preferred embodiment of the invention, the combination includes a plurality of coalescer media flexible containers retained within the coalescer chamber, with the flexible enclosures conforming to the shape of the coalescer chamber in which the flexible enclosures are placed, each of said coalescer media flexible containers having retrieval means secured to each of the flexible enclosures, and with the retrieval means extending beyond the coalescer chamber. In the preferred embodiment of the invention, a plurality of coalescer media flexible containers are installed and retained in horizontal layers within the coalescer chamber. In an alternative embodiment of the invention, the coalescer media flexible containers may be installed vertically.

There is also disclosed a method of removing dirty and replacing clean coalescer media from the coalescer chamber of an oil-water separator, comprising the steps of: (1) obtaining access to the coalescer chamber from the top of the tank used as the housing for the separator; (2) removing the lid of the coalescer chamber; (3) removing each coalescer media flexible container retained within the coalescer chamber; (4) once the coalescer chamber is empty, lowering each coalescer media flexible container filled with clean coalescer media into the coalescer chamber; (5) performing any adjustment of the coalescer media flexible container so that it conforms to the shape of the coalescer chamber; and (6) replacing the lid atop the coalescer chamber.

In the method of the invention, each coalescer media flexible container has attached thereto retrieval means, with the retrieval means enabling: (1) the flexible container to be removed from the coalescer chamber; (2) the coalescer media flexible container with clean media to be lowered into the coalescer chamber; and (3) adjustment within the coalescer chamber of the coalescer media flexible container with clean media. The method also includes the additional step of tamping at least one coalescer media flexible container.

The method also includes the additional steps of removing and replacing of a plurality of coalescer media flexible containers, with the containers when replaced being oriented substantially horizontal one to another. In one application of the method, the coalescer media flexible containers each have a top surface and a bottom surface, with the top and bottom surfaces of a given flexible container being skewed with respect to each other.

It is an object and purpose of the present invention to provide a prepackaged unit of randomly arranged coalescing media that is easy to place into and remove from the frame designed to contain such a prepackaged unit.

Another objective is to provide a prepackaged unit of randomly arranged coalescing media that can be used in cooperation with a coalescer chamber designed to contain such a prepackaged unit. An important aspect of this objective is that the prepackaged container unit be able to conform to the shape of the coalescer chamber.

Still another objective is to provide a method for using the prepackaged unit and coalescer chamber to effectuate the cleaning of the coalescer media and the replacement of cleaned coalescer media back into the coalescer chamber.

Other objects and advantages of the invention will be apparent from the following description, the accompanying drawings and the appended claims.

### BRIEF DESCRIPTION OF THE DRAWINGS

FIG. 1 is a partially exploded side elevational view showing a representative prior art sample of an oil-water separator unit.

FIG. 2 is a vertical sectional view of a representative prior art sample of an oil-water separator unit taken along line 2-2 of FIG. 1.

FIG. 3 is a vertical sectional view similar to FIG. 2, but disclosing the present invention.

FIG. 4 is a partial vertical sectional view on an enlarged scale taken along line 4-4 of FIG. 3.

FIG. 5 is a side elevational view on an enlarged scale of the lid associated with the present invention.

FIG. 6 is a perspective view of the flexible container disclosing the present invention.

FIG. 7 is a side elevational view of a plurality of flexible containers disclosing one way of practicing the method associated with the invention.

In describing the preferred embodiment of the invention which is illustrated in the drawings, specific terminology will be resorted to for the sake of clarity. However, it is not intended that the invention be limited to the specific term so selected and it is to be understood that each specific term includes all technical equivalents which operate in a similar manner to accomplish a similar purpose.

### DETAILED DESCRIPTION OF THE INVENTION

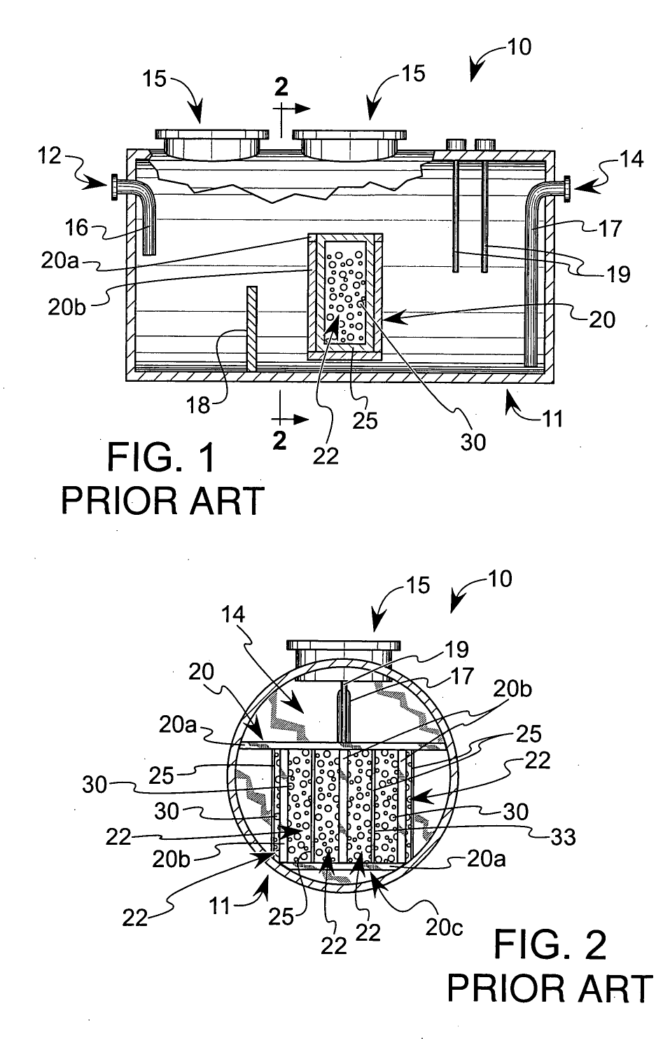

Having reference to the drawings, attention is directed first to a comparison of FIGS. 1 and 2 which disclose an oil-water separation system designated generally by the numeral 10, representative of the prior art. Most oil-water separator systems include as their major components an enclosure such as a tank 11, with an inlet end 12 and an outlet end 14. The tank is generally elongated, although the actual shape could be cylindrical, rectangular, spherical, or oblate. The tank could be constructed from metallic or synthetic material, including but not limited to such synthetic materials as plastic and fiberglass.

To assist with the cleaning of the interior of the enclosure 11, tank access means 15 is provided. The inlet end 12 features an inlet conduit 16 shown as being a pipe. Similarly, the outlet end 14 has an outlet conduit 17 also shown as being a pipe.

Near what could be characterized as the upstream side of the tank 11 is baffle 18. Near what could be characterized as the downstream side of the tank 11 are monitors 19. In prior art separators, a coalescer chamber 20 in the form of a frame is located downstream from the baffle. A typical coalescer chamber 20 includes horizontal members 20a, vertical members 20b, and a base 20c. Inside the coalescer chamber 20 is a coalescing media container 22, which in the prior art has taken the form of a rigid coalescer media container frame 25 with substantially inflexible side panels, with the coalescer media 30 being retained within the container. There are various types of coalescer media that are used in the prior art. Normally, the tolerance of the rigid containers 22 is such that a slight gap 33 exists being adjacent rigid container frames 25.

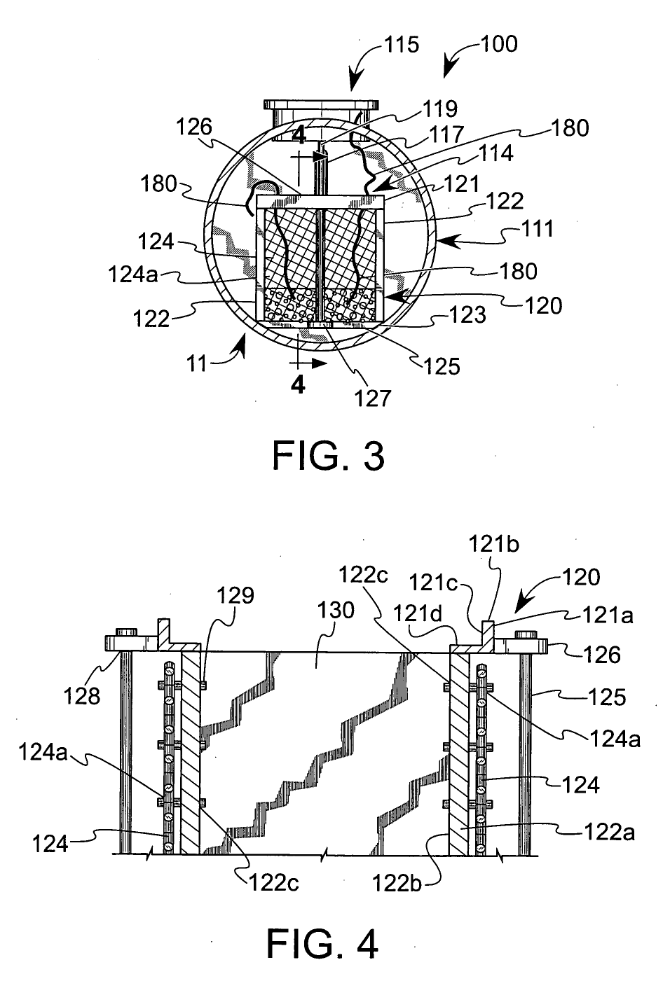

Turning now to the present invention, attention is directed first to FIG. 3 which, while similar to FIG. 2, discloses a flexible container for installing coalescing media into an oil-water separator with the invention being designated generally by the numeral 100. Major components of the oil-water separator system associated with the invention include a tank 111, with an inlet end (not shown) and an outlet end 114.

To assist with the cleaning of the interior of the enclosure 111, tank access means 115 is provided. The outlet end 114 has an outlet conduit 117 also shown as being a pipe. Near the outlet conduit 117 is at least one monitor 119.

As in prior art separators, a coalescer chamber 120 in the form of a frame is present. However, both its structure and more importantly, the structure of the container which actually holds the coalescing media are different. As can best be appreciated from a comparison of FIGS. 3 and 4, the coalescer chamber 120 associated with the invention includes horizontal members 121, vertical members 122, and a base 123. The horizontal members have an outer surface 121a, a top edge 121b, an inner surface 121c, and a base surface 121d. For example, the horizontal members could be 1″, tall, 1½″ wide and ⅜″ thick angle steel. The vertical members 122 have an outer surface 122a, an inner surface 122b, and apertures 122c.

The size of the coalescer chamber is somewhat dependant on the size of the tank and the flow rate within the tank. There also are at least one and preferably two flexible sidewalls 124 with apertures 124a. These flexible sidewalls 124 are the ones which are perpendicular to the flow through the tank 111. These sidewalls could be fabricated from a wire mesh, or plastic, or plastic-coated wire mesh having 2″ squares formed therein to permit the liquid, especially the oil, to readily flow into the interior of the coalescer chamber.

To provide additional support for the flexible sidewalls 124, a sidewall support or anchoring rod 125 is provided. This vertical rod extends from just above a first flange 126 to second flange 127. The first flange 126 is shown as being secured, preferably by a tack weld, to the outer surface 121a of the horizontal member, while the second flange 127 is shown as being secured, preferably by a tack weld, to the base 123. While the rod 125 is shown as resting on the second flange 127, it passes through an aperture 128 in the first flange 126 which serves to hold it in place relative to the coalescer chamber. If the rod 125 is a ½″ diameter rod, then the size of the aperture 128 should be about ⅝″.

The flexible sidewall 124 is attached to the vertical frame members 122 by securing means 129, which could take the form of a clip, a tie-wire, or even a cable tie by way of example. The securing means 129 can readily pass through the apertures 124a in the flexible sidewall as well as through the apertures 122c in the coalescing chamber vertical frame members 122. The actual structure of each of the end walls 130 of the coalescer chamber are not as important, and are shown as being fabricated from a planar sheet, such as steel although a plastic sheet or some type of mesh could be used.

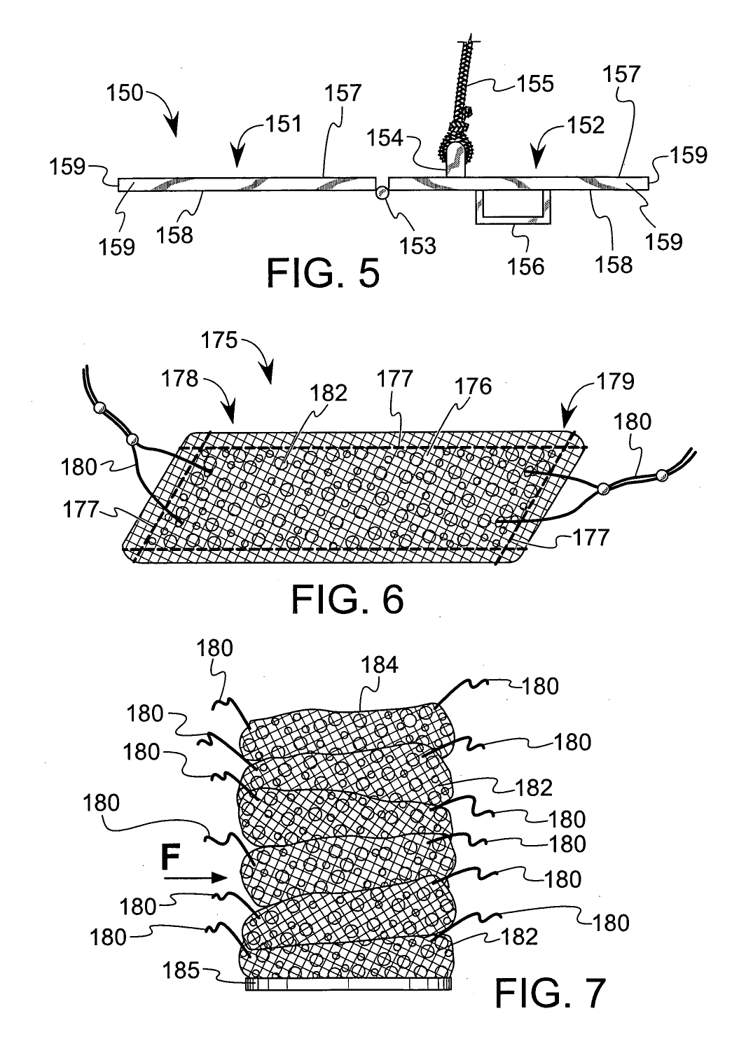

As can be appreciated by reference to FIG. 5, a lid 150 is provided for the top of the coalescer chamber due to the potential buoyancy of the coalescing media. The lid is preferably fabricated from metal and includes a first section 151 and a second section 152 connected by a hinge 153. Spaced a short distance away, which could be only a couple of inches, from the hinge and extending upwardly from the lid is a lifting eye or lifting ring 154 which will be discussed more fully in connection with the method of using the invention. Attached to the lifting ring 154 is a lid retrieval means 155 which can be a cord or cable by way of example.

A short distance, possibly no more than a couple of inches, further from the lifting ring, and yet extending downwardly is a lid fold stop 156. Although it is shown as a rectangular shaped structure, the shape is not important. The purpose of the lid fold stop is to preclude the two sections of the lid from folding completely closed, thereby making it harder to replace the lid after clean coalescing media are placed into the coalescing chamber. The lid has an upper surface 157 and a lower surface 158 in addition to an outer edge 159. The width of the lid is such that it rests between the horizontal frame of the coalescer chamber on the base surface 121d.

FIG. 6 discloses the flexible container 175 associated with the invention. The coalescer media flexible container 175 has a large number of apertures 176 formed therein. The container could be formed of netting, plastic mesh, wire mesh, fabric mesh, or one or more reinforced aerated bags. In the preferred embodiment of the invention the mesh is fabricated by polypropylene as is the coalescing media.

The flexible container 175 may be fabricated by taking a sheet and folding it over upon itself, and then securing the opposed faces of the sheet to each other through the use of seams 177. The seams 177 extend the length of the flexible container so as to create a side, but also across the first end 178 and ultimately the second end 179 of the container to create a bottom and a top when the container is filled with coalescing media 182. As mentioned with respect to the prior art, there are various types of coalescer media that have been used, and while new types of coalescer media may be introduced in the future, it should be appreciated that this invention is not limited to the specific type of coalescer media actually being used.

As can be appreciated in FIG. 6, the flexible container 175 also has at least one and preferably at least two retrieval means 180 attached to the upper surface 184 of the flexible container. These retrieval means are shown in FIG. 3 as being long enough to extend beyond the coalescer chamber. In fact, these retrieval means 180 can be made long enough to extend into and be attached to the inner sidewall of the manway or other access point into the enclosure.

FIG. 7 discloses a plurality of the flexible containers stacked upon one another along a generally horizontal axis. The lowermost container preferably has a base member 185 located inside the flexible container, and preferably secured thereto. The base member is thus directly adjacent the bottom of the flexible container.

In actual use, the coalescer chamber and flexible container associated with this invention are used in a method of removing dirty and replacing clean coalescer media from the coalescer chamber of an oil-water separator. First, access is obtained to the coalescer chamber from the top of the tank used as the housing for the separator. This can be directly from a manhole, or an access riser could be involved, or some other tank closure could facilitate entry.

Next, the lid of the coalescer chamber is removed by pulling upwardly on the lid using the lid retrieval means. The lid may be physically removed from the tank itself. Then each coalescer media flexible container retained within the coalescer chamber is removed, once again by pulling upwardly on them using the retrieval means. While there could be just a single coalescer media flexible container retained within the coalescer chamber, in most normal usages of the invention there would be more than one flexible container present. Once the coalescer chamber is empty and the dirty coalescer media have been removed from the coalescer chamber, coalescer media flexible containers filled with clean coalescer media are lowered into the coalescer chamber using the retrieval means.

Preferably by having the first flexible container also have a base member along its bottom, with the base member being dimensioned just slightly less than the area of the base of the coalescer chamber, a tight fit is obtained. As each flexible container of clean media is lowered into place any adjustment of the coalescer media flexible container can be made using the retrieval means so that the flexible container conforms to the shape of the coalescer chamber. After each flexible container is in place, the top surface of the container can be tamped with an appropriate tool to further assist in the removing air pockets which could facilitate the passage of contaminated water completely through the coalescer chamber. Finally, the lid atop the coalescer chamber is lowered into place using the lid retrieval means, so that the lid rests on top of the horizontal frame member base surface.

While it can be appreciated that the method of this invention can advantageously result in the generally horizontal alignment of the flexible containers, in one application of the method similar to what is depicted in FIG. 7, the coalescer media flexible containers each having a top surface and a bottom surface, have the top and bottom surfaces of a given flexible container skewed with respect to each other. This orientation of the containers further precludes unimpeded passage of contaminated liquid through the coalescer chamber.

While the form of apparatus and method herein described constitutes a preferred embodiment of the present invention, it is to be understood that the invention is not limited to this precise form of apparatus and method, and that changes may be made therein without departing from the scope of the invention which is defined in the appended claims.

1. A coalescer media flexible container for retaining coalescer media in the coalescer chamber of an oil-water separator, said coalescer media flexible container comprising
a flexible enclosure having a top surface and a bottom surface, said top surface and said bottom surface being connected to each other, said flexible enclosure conforming to the shape of the coalescer chamber in which said flexible enclosure is placed, said flexible enclosure having an interior, said flexible enclosure fabricated so as to permit oil to easily pass into said interior of said flexible enclosure, and
randomly arranged, loosely packed coalescing medium retained in said interior of said flexible enclosure.

2. The coalescer media flexible container according to claim 1 wherein said flexible enclosure is fabricated from a group of materials including plastic mesh, reinforced aerated plastic bags, wire mesh, fabric mesh, and netting.

3. The coalescer media flexible container according to claim 1 which includes a planar sheetform member, said sheetform member being placed in the interior of said flexible enclosure directly adjacent said bottom surface.

4. The coalescer media flexible container according to claim 3 wherein said sheetform member is secured to said bottom surface.

5. The coalescer media flexible container according to claim 2 wherein said flexible enclosure is fabricated from polypropylene.

6. The coalescer media flexible container according to claim 1 which includes retrieval means secured to said flexible enclosure.

7. The coalescer media flexible container according to claim 6 wherein said retrieval means are secured to said top surface of said flexible enclosure.

8. The coalescer media flexible container according to claim 6 which includes at least a pair of retrieval means and wherein said flexible enclosure has a first end and a second end, at least one of said retrieval means being secured to said first end and at least one other of said retrieval means being secured to said second end.

9. In combination a coalescer chamber of an oil-water separator and at least one coalescer media flexible container for retaining coalescer media in said coalescer chamber,
said coalescer chamber comprising a frame and a lid, said frame having a base, said frame also having secured thereto first and second sidewalls, said first and second sidewalls fabricated so as to permit liquids to easily pass therethrough, and
said coalescer media flexible container comprising
a flexible enclosure containing randomly arranged, loosely packed coalescing media, said flexible enclosure having a top surface and a bottom surface, said top surface and said bottom surface being connected to each other, said flexible enclosure conforming to the shape of said coalescer chamber in which said flexible enclosure is placed, said flexible enclosure having an interior, said flexible enclosure fabricated so as to permit liquids to easily pass into said interior of said flexible enclosure.

10. The combination according to claim 9 wherein said coalescer chamber sidewalls are fabricated from a steel mesh screening.

11. The combination according to claim 9 wherein said frame has attached thereto a pair of anchoring rods, said anchoring rods extending substantially parallel to said coalescer chamber sidewalls.

12. The combination according to claim 9 wherein said coalescer media flexible container includes a planar sheetform member, said sheetform member being placed in the interior of said flexible enclosure directly adjacent said bottom surface, said bottom surface also being directly adjacent said coalescer chamber frame base.

13. The combination according to claim 9 wherein said coalescer media flexible container has retrieval means secured to said top surface of said flexible enclosure.

14. The combination according to claim 9 which includes a plurality of coalescer media flexible containers retained within said coalescer chamber, said flexible enclosures conforming to the shape of said coalescer chamber in which said flexible enclosures are placed, each of said coalescer media flexible containers having retrieval means secured to each of said flexible enclosures, said retrieval means extending beyond said coalescer chamber.

15. The combination according to claim 9 which includes a plurality of coalescer media flexible containers retained in horizontal layers within said coalescer chamber.

16. The method of removing dirty and replacing clean coalescer media from the coalescer chamber of an oil-water separator, comprising the steps of:
obtaining access to the coalescer chamber from the top of the tank used as the housing for the separator,
removing the lid of the coalescer chamber,
removing each coalescer media flexible container retained within said coalescer chamber,
once the coalescer chamber is empty, lowering each coalescer media flexible container filled with clean coalescer media into said coalescer chamber,
performing any adjustment of said coalescer media flexible container so that it conforms to the shape of the coalescer chamber, and
replacing the lid atop said coalescer chamber.

17. The method according to claim 16 wherein each coalescer media flexible container has attached thereto retrieval means, said retrieval means enabling said flexible container to be removed from said coalescer chamber, said retrieval means enabling said coalescer media flexible container with clean media to be lowered into said coalescer chamber, and said retrieval means enabling adjustment within said coalescer chamber of said coalescer media flexible container with clean media.

18. The method according to claim 16 which includes the additional step of tamping at least one coalescer media flexible container.

19. The method according to claim 16 which includes the additional steps of removing and replacing of a plurality of coalescer media flexible containers, said containers when replaced being oriented substantially horizontal one to another.

20. The method according to claim 19 wherein said coalescer media flexible containers each have a top surface and a bottom surface, with said top and bottom surfaces being skewed with respect to each other.
